(19) United States
(12) Patent Application Publication
(10) Pub. No.: US 2005/0025557 A1
(43) Pub. Date: Feb. 3, 2005

(54) Packaging and dispensing device

(76) Inventor: Vincent De LaForcade, Rambouillet (FR)

Correspondence Address: Thomas L. Irving;FINNEGAN, HENDERSON, FARABOW,, GARRETT & DUNNER, L.L.P., 1300 I Street, N.W., Washington, DC, 20005-3315, US

(21) Appl. No.: 10/873,172

(22) Filed: Jun. 23, 2004

Related U.S. Application Data
(60) Provisional application No. 60/485,711, filed on Jul. 10, 2003.

(30) Foreign Application Priority Data
Jun. 23, 2003 (FR) 03 07546

(51) Int. Cl. B67D 5/64

(52) U.S. Cl. 401/129

(57) ABSTRACT

The present invention provides a receptacle (1) including at least one outlet orifice for dispensing a substance contained inside the receptacle, in particular a hair-coloring product, the receptacle being characterized by the fact that it presents a first face configured in such a manner that while the receptacle is resting via the first face on a horizontal plane surface, a decrease in the quantity of substance in the receptacle causes it to tilt, without it being possible for the substance to run out through said outlet orifice.

The present invention relates to packaging and dispenser devices for cosmetics, including care products.

The invention relates more particularly, but not exclusively, to devices enabling locks of hair to be colored.

When a person desires to color locks of hair with a color different from the remainder of the hair, it is necessary to take care to place the hair-coloring product only at selected locations while also paying attention to the positions of locks that have already been colored. While actually in the process of coloring locks, it is frequently necessary to put down the receptacle containing the hair-coloring product in a hurry and to pick it by up again subsequently. Under such circumstances, a person finds it difficult to pay careful attention to the way in which the receptacle containing the hair-coloring product is put down, and with conventional receptacles of generally cylindrical shape there is a risk of the receptacle toppling over accidentally.

Unfortunately, hair-coloring products are liable to stain strongly any medium onto which they might accidentally be spilt.

It is therefore appropriate to ensure that there is no accidental leakage or spilling of the product.

In addition, hair-coloring products are often relatively viscous, which delays delivery of the product each time that the user makes use again of the receptacle after it has been put down. This makes the treatment lengthier and more difficult to perform.

Finally, coloring products may comprise two components for mixing extemporaneously, in particular an oxidizer and a coloring agent. With conventional receptacles, these components can be found to be relatively difficult to mix together.

There therefore exists a need to benefit from a receptacle which can be put down after use without paying particular attention to this operation and which limits any risk of accidental escape of the product.

There also exists a need to benefit from a receptacle which avoids the user having to wait for too long a time before the product can be dispensed again after picking up a receptacle that has previously been put down.

There also exists a need to have a receptacle which is relatively simple to manufacture and of a cost that is compatible with mass marketing.

The invention seeks to satisfy these needs in full or in part.

In a first of its aspects, the invention provides a receptacle including at least one outlet orifice for dispensing a substance contained inside, in particular a hair-coloring product, the receptacle presenting a first face configured in such a manner that while the receptacle is resting via said first face on a horizontal plane surface, a decrease in the quantity of substance in the receptacle causes it to tilt, without it being possible for the substance to run out through said outlet orifice.

Preferably, the first face is configured in such a manner that tilting the receptacle tends to move the outlet orifice downwards.

Thus, when the receptacle is put down, a certain quantity of substance can remain inside the receptacle in the vicinity of the outlet orifice, thereby reducing the time needed for the substance to reach the outlet orifice at the next moment of use. This enables hair to be treated more quickly, with greater accuracy or more comfortably.

In a particular embodiment of the invention, the receptacle is configured so that when it rests via the first face on the horizontal plane surface, and while it contains substance for dispensing, the center of gravity of the partly-filled receptacle moves towards the outlet orifice as the quantity of substance in the receptacle decreases. The receptacle may also be arranged in such a manner that while it is resting via the first face on the horizontal plane surface and while it contains substance for dispensing, it tilts about geometric instantaneous pivot axes that are parallel to one another and to said surface as the quantity of substance in the receptacle decreases.

Furthermore, when the receptacle is resting via the first face on the horizontal plane surface, a given quantity of substance contained in the receptacle can define in one-to-one correspondence a corresponding stable equilibrium position.

The receptacle may be made without any ballast, i.e. without any mass fitted thereto, thus enabling manufacture to be at relatively low cost.

In a particular embodiment of the invention, the receptacle comprises a body of width that is equal to its length to within 25%, and better to within 15%. This shape makes it easier to mix a plurality of components inserted into the receptacle, in particular an oxidizer and a coloring agent.

The receptacle may comprise a body and a dispenser head. The body may be elongate along a longitudinal axis and the dispenser head may extend along an axis forming a non-zero angle with the longitudinal axis. The angle between the axis of the dispenser head and the longitudinal axis of the receptacle body may lie, in particular, in the range 10° to 30°, for example in the range 15° to 25°.

The receptacle may include a neck with the dispenser head fixed thereon, e.g. by screw fastening or snap-fastening. The dispenser head may thus comprise an assembly portion arranged to be screw-fastened on the neck, or in a variant snap-fastened thereon. The neck and the body of the receptacle may be made as a one-piece molding of a plastics material, in particular polyethylene (PE), polypropylene (PP), and in general polyolefins, polyamide, polyester, or polyvinyl chloride (PVC).

The neck may include a portion in relief enabling the dispenser head to be positioned in a predetermined angular orientation relative to the body of the receptacle, particularly when the dispenser head is held to the neck by snap-fastening.

The dispenser head may include an applicator portion.

In an embodiment of the invention, the applicator portion may be arranged to comb the hair, and may include at least one tooth that extends substantially parallel to an axis of the dispenser head. The applicator portion may comprise, in particular, at least one row of teeth, for example two rows of teeth that are substantially parallel. The outlet orifice may open out between these rows of teeth. In a variant, at least one tooth may be hollow and the outlet orifice may open out in the end of said tooth or in the vicinity of said end.

The applicator portion may include at least one row of teeth, e.g. two rows, with the axis of the row extending in a direction that is substantially parallel to the horizontal plane surface when the receptacle is resting via the first face thereon.

The applicator portion may be made, for example, by injecting a plastics material, e.g. PE, PP, and in general polyolefins, polyamide, polyester, PVC, polymethyl methacrylate, . . . .

The first face may be outwardly convex. On a second face opposite from the first, the receptacle may include at least one indentation, in particular an indentation situated substantially in the center of the second face. The second face may be generally outwardly convex in shape, apart from said indentation.

The capacity of the receptacle may lie in the range, for example, 10 milliliters (mL) to 500 mL, for example it may be about 150 mL.

The present invention can be better understood on reading the following detailed description of non-limiting embodiments thereof, and on examining the accompanying drawings, in which:

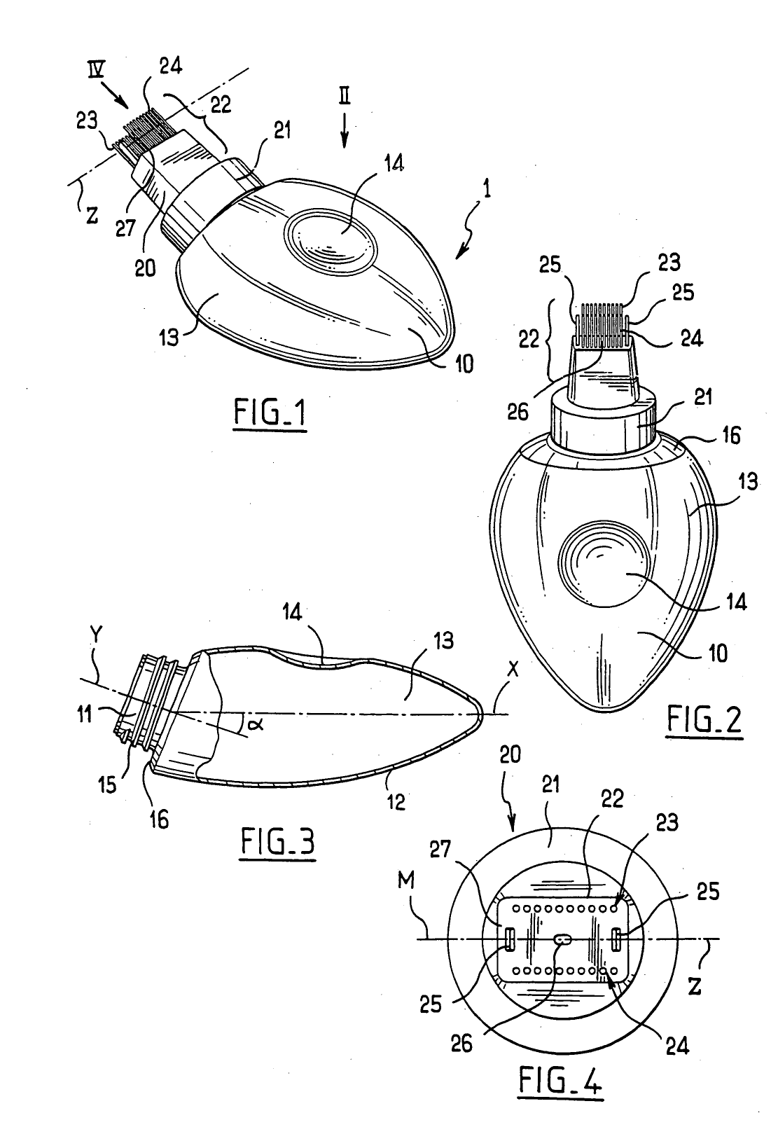

FIG. 1 is a diagrammatic perspective view showing an embodiment of a receptacle in accordance with the invention;

FIG. 2 is a plan view looking along arrow II of FIG. 1;

FIG. 3 shows in isolation, in elevation and partially in longitudinal section, the FIG. 1 receptacle without its dispenser head;

FIG. 4 is a diagrammatic view looking along FIG. 1 receptacle;

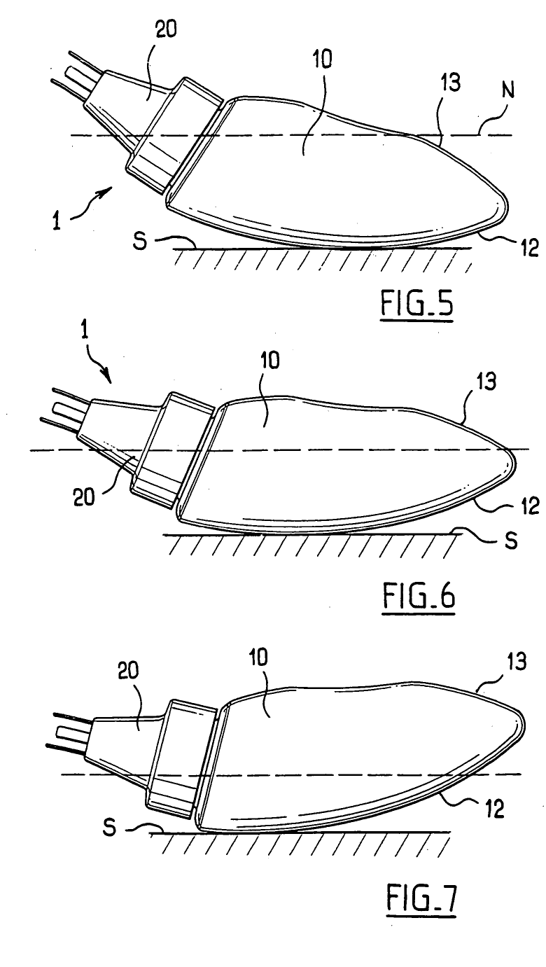

FIGS. 5 to 7 show how the receptacle tilts as it becomes progressively emptier; and

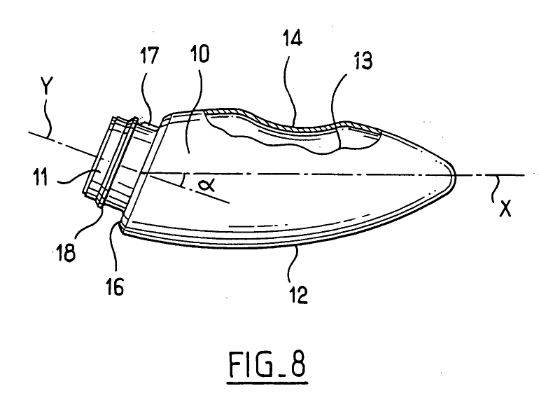

FIG. 8 is an elevation view in partial longitudinal section showing in isolation a variant embodiment of a receptacle.

The receptacle 1 shown in FIGS. 1 and 2 comprises in particular a body 10 and a dispenser head 20.

The body 10 is shown in FIG. 3. As can be seen in this figure, the body 10 is generally flat in shape and elongate along a longitudinal axis X. At one longitudinal end, the body 10 has an opening which opens out in a neck 11 of axis Y. The neck 11 is connected to a shoulder 16 of the body 10, which shoulder extends generally substantially perpendicularly to the axis Y. The axis Y is an angle a relative to the longitudinal axis X. By way of example, this angle α is close to 22° in the example described.

The body 10 presents two main opposite faces, a bottom face and a top face referred to as a first face 12 on which the receptacle rests when not in use, and a second face 13 opposite from the first.

In the example described, the receptacle 1 is of a shape that is symmetrical about a midplane containing the axes X and Y. The body 10 is generally flat in a plane perpendicular to said midplane.

In its central region, the second face 13 includes an indentation 14 defining a zone which the user can press, in a manner described in greater detail below.

In the embodiment described, the body 10 of the receptacle 1 is made integrally with the neck 11 by molding a plastics material, e.g. by using a blow-molding technique.

The wall of the body 10 is flexible, and each time pressure is exerted on the body 10 to dispense the substance it contains, the wall can return to its initial shape because of its elasticity.

The dispenser head 20 may be made and assembled with the remainder of the receptacle 1 in numerous ways.

In the example described, the dispenser head 20 includes an assembly portion 21 enabling it to be fixed in a determined position on the neck 11, this assembly portion 21 being, for example, in the form of a skirt provided on the inside with a hidden thread that screw-fastens on a thread 15 on the neck 11.

The dispenser head 20 also comprises an applicator portion 22 which, in the example described, comprises two rows of teeth 23 and 24, these rows of teeth extending parallel to an axis Z, as can be seen in FIG. 4. The axis Z is perpendicular to the axis Y of the neck 11, once the dispenser head 20 has been fastened thereon.

The applicator portion 22 also comprises, on either side of the rows 23 and 24 of teeth, two end teeth 25 each of a generally flat shape in a direction that is perpendicular to the axis Z, and having bases that are situated substantially along a midplane of symmetry M of the applicator portion 22, said plane containing the axis Z.

In the example described, each row 23 or 24 of teeth comprises ten teeth, however it would not go beyond the ambit of the present invention for the number of teeth to be different, or for the teeth to be replaced by applicator elements of some other kind, for example tufts of bristles.

An orifice 26 for delivering the substance opens out between the rows 23 and 24 of teeth, said orifice 26 being made through the wall 27 of the applicator portion 22 from which the teeth project. It would not go beyond the ambit of the present invention for the dispenser head to have more than one orifice. In a variant that is not shown, at least one substance outlet orifice opens out close to the end or at the end of at least one tooth, the tooth being hollow.

In accordance with an aspect of the invention, the first face 12 is configured in such a manner that while the receptacle 1 is placed on a horizontal plane surface S, the orifice 26 moves downwards as the receptacle is progressively emptied, as shown in FIGS. 5 to 7.

In these figures a dashed line N represents the level of the substance within the receptacle 1.

In FIG. 5, the receptacle is full and the center of gravity of the assembly constituted by the receptacle and the liquid it contains is relatively far away from the dispenser head 20. The dispenser head points upwards and about 45° relative to the surface S. In FIG. 6, the quantity of substance is smaller, and because of the shape of the receptacle, and in particular because of the shape of its first face 12, the center of gravity has shifted towards the dispenser head 20. The equilibrium position of the empty receptacle is different from the equilibrium position of the full receptacle and the orientation of the receptacle varies as a function of the extent to which it is filled.

The first face 12 is arranged in such a manner as to enable the receptacle 1 to tilt on the surface S under the effect of the couple generated by the shift in the center of gravity, thereby enabling the receptacle to reach a position of stable equilibrium regardless of the extent to which it is filled.

By way of example, the first face 12 may be almost spherical, without any flat.

The distance inside the receptacle between the wall portions of the body 10 that define the first and second faces 12 and 13 respectively, as measured perpendicularly to the axis X in the midplane of symmetry of the receptacle, tends to decrease on approaching the end of the body 10 remote from the neck 11, beyond the indentation 14.

FIG. 7 is a view analogous to FIG. 6 after the receptacle has been emptied some more.

The downward tilt of the orifice 26 enables a certain quantity of substance to be maintained in and/or close to the dispenser head 20.

Thus, when the user presses on the indentation 14 in the second face 13, substance is expelled without it being necessary to wait for too long a time to allow the substance to flow under gravity towards the outlet orifice 26.

This makes the receptacle easier to use.

In addition, the first face 12 is arranged in such a manner that regardless of the equilibrium position of the receptacle 1 while it is resting via said first face 12 on the horizontal plane surface S, the level N of substance in the receptacle remains below the outlet orifice 26.

On examining FIGS. 5 and 7, it may also be observed that in the example described, the axis Z remains oriented substantially parallel to the horizontal plane surface S while the receptacle is tilting.

When there is no substance contained in the receptacle, it tends to rest on the surface S with the axis Y of the neck 11 in a nearly horizontal position.

In order to use the receptacle 1, the user separates, where necessary, the dispenser head 20 from the body 10 so as to be able to insert into the receptacle 1 the components that are to be mixed in order to obtain the hair-coloring product, for example an oxidizer and the corresponding coloring agent, which were previously packaged separately. Thereafter, the user can put the dispenser head 20 into position on the neck 11.

The flat shape of the receptacle encourages mixing of the components.

Thereafter, the user can dispense the hair-coloring product by pressing in the indentation 14 so as to bring the first and second faces 12 and 13 closer together. When the user puts the receptacle 1 down after treating a lock, the receptacle tends to retain a certain quantity of substance close to the outlet orifice 26, as explained above.

Naturally, the invention is not limited to the embodiments described above.

Various modifications can be applied, in particular to the shape of the body 10 of the receptacle and to the shape of the applicator portion 22. The applicator portion may be fastened to the receptacle other than by screw-fastening, or it may be made integrally with the body of the receptacle.

By way of example, FIG. 8 shows a receptacle 10 whose neck 11 carries an annular bead 15 enabling the dispenser head 20 to be snap-fastened thereon, and a portion in relief 17 which is located in the example described between the bead 15 and the shoulder 16, said portion in relief 17 being, for example, in the form of a spline extending parallel to the axis Y. The portion in relief 17 is for co-operating with complementary relief (not shown in the drawings) within the dispenser head 20 so that the dispenser head is fastened on the body 10 in a particular orientation.

Throughout the description, including in the claims, the term “comprising a” should be understood as being synonymous with “comprising at least one” unless specified to the contrary.

1. A receptacle (1) including at least one outlet orifice (26) for dispensing a substance (P) contained inside the receptacle, in particular a hair-coloring product, the receptacle being characterized by the fact that it presents a first face (12) configured in such a manner that while the receptacle is resting via said first face on a horizontal plane surface (S), a decrease in the quantity of substance in the receptacle causes it to tilt, without it being possible for the substance to run out through said outlet orifice.

2. A receptacle according to the preceding claim, characterized by the fact that the first face is configured in such a manner that the tilting of the receptacle in response to a decrease in the quantity of substance contained inside it tends to lower the outlet orifice (26).

3. A receptacle according to any one of the preceding claims, characterized by the fact that it is configured so that while it is resting via the first face (12) on the horizontal plane surface (S) and while it contains substance to be dispensed, the center of gravity of the receptacle plus the substance shifts towards the outlet orifice (26) with a decrease in the quantity of substance in the receptacle.

4. A receptacle according to any one of the preceding claims, characterized by the fact that it is arranged in such a manner that while it is resting via the first face (12) on the horizontal plane surface (S) and while it contains substance to be dispensed, it tilts about geometric instantaneous tilt axes that are parallel to one another and to said surface as the quantity of substance in the receptacle decreases.

5. A receptacle according to any one of the preceding claims, characterized by the fact that the receptacle is configured in such a manner that while it is resting via the first face on the horizontal plane surface (S), a given quantity of substance contained in the receptacle defines in one-to-one correspondence a corresponding stable equilibrium position.

6. A receptacle according to any one of the preceding claims, characterized by the fact that it is not provided with any ballast.

7. A receptacle according to any one of the preceding claims, characterized by the fact that it presents a body (10) of width that is equal to its length to within 25%, and better to within 15%.

8. A receptacle according to any one of the preceding claims, characterized by the fact that it comprises a body (10) and a dispenser head (20).

9. A receptacle according to the preceding claim, characterized by the fact that the body (10) is elongate along a longitudinal axis (X) and by the fact that the dispenser head (20) extends along an axis (Y) forming a non-zero angle (α) with the longitudinal axis (X).

10. A receptacle according to the preceding claim, characterized by the fact that the angle (α) between the axis (Y) of the dispenser head (20) and the longitudinal axis (X) of the body (10) of the receptacle lies in the range 10° to 30°, and preferably in the range 15° to 25°.

11. A receptacle according to any one of the claims 9 to 10, characterized by the fact that it includes a neck (11) on which the dispenser head (20) is fastened.

12. A receptacle according to the preceding claim, characterized by the fact that the dispenser head (20) includes an assembly portion (21) arranged to screw-fasten on the neck (11).

13. A receptacle according to any one of claims 1 to 11, characterized by the fact that the dispenser head (20) includes an assembly portion (21) arranged to snap-fasten on the neck (11), and by the fact that the neck (11) includes a portion in relief (17) enabling the dispenser head (20) to be positioned angularly in a predetermined orientation relative to the body (10) of the receptacle.

14. A receptacle according to any one of claims 8 to 13, characterized by the fact that the applicator portion (22) is disposed on the dispenser head (20).

15. A receptacle according to the preceding claim, characterized by the fact that the applicator portion (22) is arranged to comb the hair.

16. A receptacle according to the preceding claim, characterized by the fact that the applicator portion includes at least one tooth extending substantially parallel to an axis of the dispenser head.

17. A receptacle according to any one of claims 15 and 16, characterized by the fact that the applicator portion (22) comprises at least one row of teeth, and in particular two substantially parallel rows of teeth (23, 24).

18. A receptacle according to the preceding claim, characterized by the fact that the outlet orifice (26) opens out between the rows of teeth.

19. A receptacle according to any one of claims 15 to 18, characterized by the fact that the applicator portion (22) includes at least one row of teeth, said row extending in a direction (Z) substantially parallel to the horizontal plane surface (S) while the receptacle is resting thereon via the first face (12).

20. A receptacle according to any one of the preceding claims, characterized by the fact that the first face (12) is outwardly convex.

21. A receptacle according to the preceding claim, characterized by the fact that it includes at least one indentation in a second face (13) opposite to its first face, in particular an indentation (14) situated substantially in the center of the second face.

22. A receptacle according to the preceding claim, characterized by the fact that the second face (13) is generally outwardly convex in shape, apart from said indentation (14).

23. A receptacle according to any one of the preceding claims, characterized by the fact that it contains a hair-coloring product.

24. A receptacle according to any one of the preceding claims, characterized by the fact that its capacity lies in the range 10 mL to 500 mL, and in particular is 150 mL.
